(19) United States
(12) Patent Application Publication
(10) Pub. No.: US 2012/0236251 A1
(43) Pub. Date: Sep. 20, 2012

(54) EYEGLASSES ASSEMBLY

(75) Inventor: Shun-Tien Yang, Tainan City (TW)

(73) Assignee: ALL-LOGIC INT. CO., LTD., Tainan City (TW)

(21) Appl. No.: 13/421,566

(22) Filed: Mar. 15, 2012

(30) Foreign Application Priority Data
Mar. 18, 2011 (TW) 100204902

(51) Int. Cl. G02C 5/14

(52) U.S. Cl. 351/116

(57) ABSTRACT

An eyeglasses assembly includes a pair of pivot units to detachably connect a lens unit to a pair of temple units. Each pivot unit has a pivot rod. Each temple unit has two vertically spaced hook members formed at an end of a temple body to engage detachably the pivot rod and to permit the temple body to rotate about the pivot rod relative to the lens unit. With the use of the hook members, convenient assembly and disassembly of the temple units is permitted for replacement.

### BACKGROUND OF THE INVENTION

### Cross-Reference To Related Application

This application claims priority of Taiwanese Patent Application No. 100204902 filed on Mar. 18, 2011.

1. Field of the Invention

The present invention relates to eyeglasses and, more particularly, to eyeglasses with replaceable temples.

2. Description of the Related Art

Eyeglasses have been designed differently for different use occasions. For example, to avoid dropout of the eyeglasses due to violent actions, the eyeglasses for use in sport or industry may utilize an elastic band that is fitted around a wearer's head to position firmly the eyeglasses on the wearer's face. There are many eyeglasses with replaceable temples in the art in order to improve the versatility for eyeglasses.

Referring to FIG. 1, a conventional pair of eyeglasses generally comprises: a frame unit 91, a pair of temple units 92 mounted respectively on the opposite sides of the frame unit 91, and two pins 93 that is tapered in shaped and that are detachably and respectively inserted so as to connect the frame unit 91 and the temple units 92. The frame unit 91 includes two pairs of ring members 911 disposed respectively on two sides thereof, and two pairs of insertion holes 912 defined respectively by the two pairs of ring members 911. One of the two pairs of ring members 911 at the same side are spaced apart from one another so that one of the two pairs of the insertion holes 912 can be aligned with one another. Each of the temple units 92 has a pair of ring members 921 that are formed at a front end thereof and that are spaced apart from one another in a generally vertically direction, and a pair of insertion holes 922 that are defined respectively by the pair of ring members 921 and that are aligned with one another in a top-bottom direction. In assembly, the frame unit 91 and the temple units 92 are inserted one in another such that the ring members 911 and 921 are alternated in a stack. Each of the pins 93 is inserted into the insertion holes 912 and the insertion holes 922 at either side of the frame unit 91 to complete assembly. Since the pins 93 is embedded in the ring members 911 and the ring members 921, a tool is required to push out the pins 93 for disassembling the frame unit 91 and the temple units 92. In addition, because the pins 93 are tapered and fitted firmly in the ring members 911 and the ring members 921, it is difficult to detach the pins 93.

### SUMMARY OF THE INVENTION

Therefore, an object of the present invention is to provide an eyeglasses assembly with temples that can be easily replaced.

Accordingly, an eyeglasses assembly of the present invention comprise: a lens unit, a pair of pivot units disposed respectively on two sides of the lens unit, and a pair of temple units. Each of the pivot units includes a pivot rod. The temple units are connected detachably and respectively to the pivot rods of the pivot units. Each of the temple units includes a temple body, and two hook members that are spaced apart from one another in a top-bottom direction and that are formed at an end of the temple body. The hook members of each of the temple units are engaged detachably to a respective one of the pivot rods to connect the temple body to the lens unit and to enable the temple bodies to pivot relative to the lens unit between a folded position and an unfolded position.

The advantageous effects of the eyeglasses assembly of the present invention are as follows: Because the temple units are connected to the lens unit through the hook members in a snap-in manner, the wearer is permitted to detach the temple units directly from the lens unit and replace the temple units easily. Moreover, the eyeglasses assembly can be manipulated conveniently.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of the conventional eyeglasses;

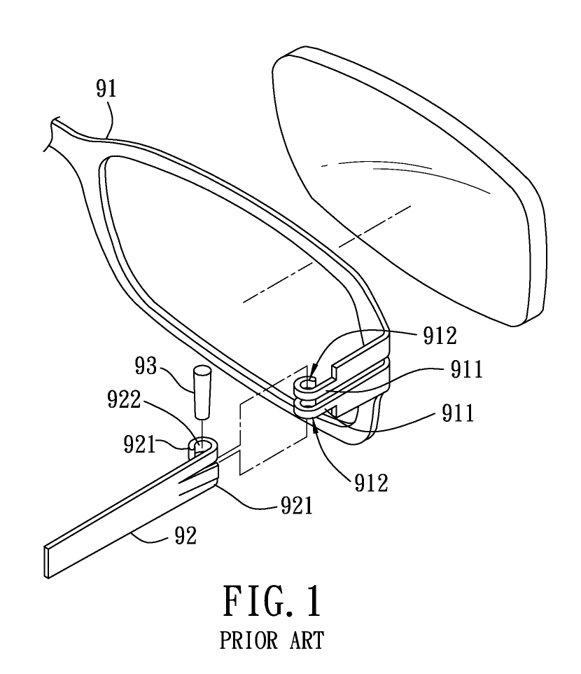

FIG. 2 is a perspective view of a first preferred embodiment of an eyeglasses assembly according to the present invention;

FIG. 3 is a fragmentary exploded perspective view illustrating a frame, a pivot member, and a temple unit of the eyeglasses assembly of the first preferred embodiment;

FIG. 4 is an exploded top sectional view, illustrating the frame, the pivot member, and the temple unit;

FIG. 5 is a sectional top plan view illustrating the temple unit in an unfolded position;

FIG. 6 is the same view as FIG. 5, but illustrating the temple unit in a folded position;

FIG. 7 is a side view illustrating the temple unit of the first preferred embodiment in an upper position;

FIG. 8 is a side view illustrating the temple unit of the first preferred embodiment in a lower position;

FIG. 9 is a perspective view of a second preferred embodiment of the eyeglasses assembly according to the present invention; and

FIG. 10 is an exploded perspective view of a third preferred embodiment of the eyeglasses assembly according to the present invention.

### DETAILED DESCRIPTION OF THE PREFERRED EMBODIMENTS

Before the present invention is described in greater detail, it should be noted that like components are assigned the same reference numerals throughout the following disclosure.

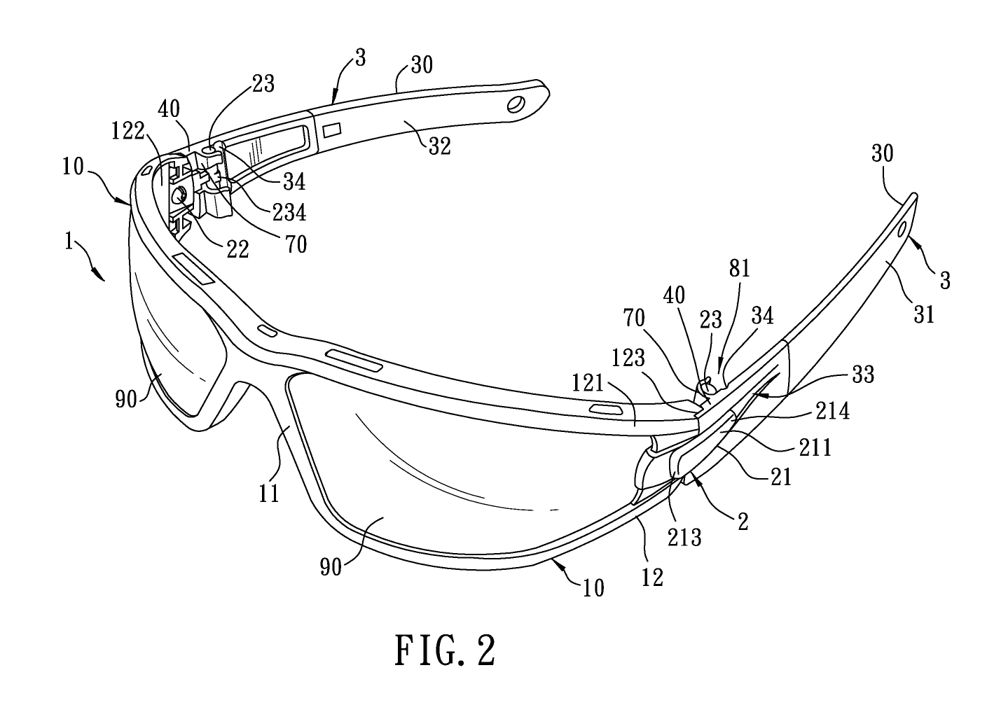

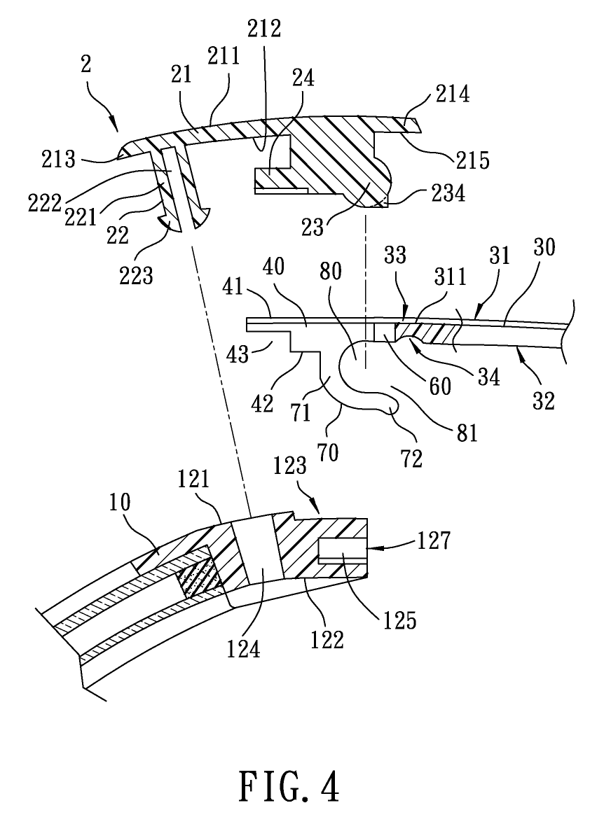

Referring to FIGS. 2 to 8, a first preferred embodiment of the eyeglasses assembly according to the present invention comprises a lens unit 1, a pair of pivot members 2 disposed on two sides of the lens unit 1, and a pair of temple units 3 disposed on two sides of the lens units 1. The lens unit 1 has a pair of frames 10 arranged symmetrically on left and right sides thereof, and two lenses 90 mounted respectively in the frames 10. It is worth mentioning that, since the eyeglasses assembly is symmetrical, only one of the frames 10, one of the pivot members 2 and one of the temple units 3 on the same side of the lens unit 1 are described hereinafter.

Each of the frames 10 is generally in the shape of a loop, and includes an inner section 11 that is proximate to the other one of the frames 10, and an outer section 12 that is spaced apart from the inner section 11. The outer section 12 has a frame front face 121 at a front side of the frame 10, a frame rear face 122 opposite to the frame front face 121, a frame recessed portion 123 indented from the frame front face 121, a pivot hole 124 extending therethrough from the frame front face 121 to the frame rear face 122, a limiting slot 125 that is indented from an outer side thereof, and a slot wall surface 126 bounding the limiting slot 125. The frame recessed portion 123 extends along the outer periphery of the frame front face 121 and is arcuate in shape.

The limiting slot 125 is located on one side of the outer section 12 that is distal from the inner section 11 and extends generally in a top-bottom direction. In addition, the limiting slot 125 has an open end 127. The slot wall surface 126 has a top wall face 128 on top of the limiting slot 125, and a bottom wall face 129 at the bottom of the limiting slot 125. The top wall face 128 and the bottom wall face 129 are sloped faces and extend inward and toward one another from the open end 127. The pivot hole 124 is tapered from the frame front face 121 to the frame rear face 122 and is larger in diameter at the frame front face 121 than at the frame rear face 122.

The pivot member 2 is mounted on the outer section 12 and has a pivot base wall 21, a mounting block 22 that projects from the pivot base wall 21, a pivot rod 23 connected to the pivot base wall 21, and a sliding plate 24 that is spaced apart from the pivot base wall 21. The pivot base wall 21 is elongated and has an outer wall surface 211, an inner wall surface 212 opposite to the outer wall surface 211, a front end 213, and a rear end 214 opposite to the front end 213. The inner wall surface 212 has an abutting section 215 adjacent to the rear end 214.

The mounting block 22 is disposed at the inner wall surface 212 adjacent the front end 213 and is cylindrical in shape. The mounting block 22 is inserted through the pivot hole 124 and has a pair of spaced-apart resilient portions 221 that extend away from the inner wall surface 212, and a buffer slit 222 that is formed between the resilient portions 221. Each of the resilient portions 221 has an enlarged portion 223 projecting transversely from a free end thereof.

The pivot rod 23 is disposed on the inner wall surface 212 in a top-bottom direction in proximity to the rear end 214 in this embodiment. The pivot rod 23 has an upper portion 231 proximate to the upper end thereof, a lower portion 232 proximate to the lower end thereof, an intermediate portion 233 that interconnects the upper portion 231 and the lower portion 232, and a protrusion 234 that projects from the intermediate portion 233. The intermediate portion 233 is fixed to the inner wall surface 212. The sliding plate 24 extends generally parallel to the pivot base wall 21, is positioned between the pivot rod 23 and the mounting block 22, and is connected to the intermediate portion 233 of the pivot rod 23. The sliding plate 24 is in the shape of a trapezoid and is narrowed gradually in a direction from the pivot rod 23 toward the mounting block 22 and is spaced apart from the mounting block 22.

The temple unit 3 is mounted on the pivot member 2 and includes an elongated temple body 30, two pivot end portions 40 that are connected to a front end of the temple body 30 and that are spaced apart in a top-bottom direction, a temple recess 50 that is formed between the pivot end portions 40, a projection 60 that protrudes from the front end of the temple body 30 into the temple recess 50, two hook members 70 that are connected respectively to the pivot end portions 40, and two hook grooves 80 that are defined respectively by the hook members 70. The temple body 30 has a temple outer face 31 that faces outwardly, a temple inner face 32 opposite to the temple outer face 31, a temple outer groove 33 formed in the temple outer face 31, and a positioning recess 34 formed in the temple inner face 32.

The temple outer face 31 has an abutting section 311 proximate to the front end of the temple body 30. The temple outer groove 33 extends from the front end of the temple body 30 along a length direction of the temple body 30. The abutting section 311 is formed inside the temple outer groove 33. The positioning recess 34 extends in a top-bottom direction and is proximate to the front end of the temple inner face 32. In this embodiment, the pivot end portions 40 are integrally formed with the temple body 30. Each of the pivot end portions 40 has a pivot outer face 41 that faces outwardly, a pivot inner face 42 opposite to the pivot outer face 41, and an end notch 43 that is formed in the pivot inner face 42 adjacent the front end thereof.

In this embodiment, the hook members 70 are C-shaped rings and are connected respectively to the pivot inner faces 42 of the pivot end portions 40 between the end notches 43 and the temple body 30. Each of the hook members 70 has a hook body 71 that curves toward the pivot inner face 42, a hook lip 72 that extends from a distal end of the hook body 71 in a direction away from the pivot inner face 42. The hook groove 80 has a mouth portion 81 defined by the hook lip 72. The mouth portion 81 of the hook groove 80 is opened toward the temple body 30 and is proximate to the positioning recess 34 of the temple body 30.

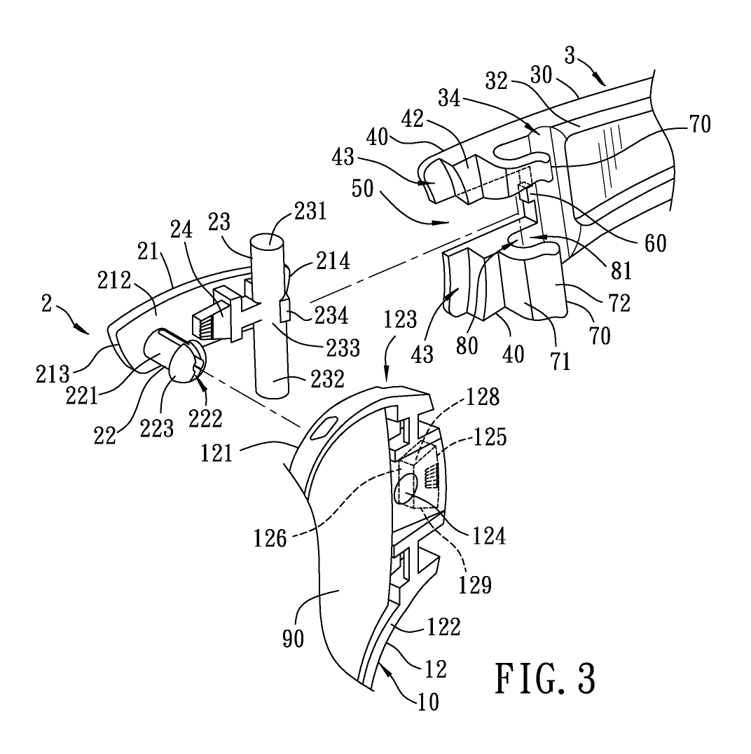

Referring to FIGS. 3, 4 and 5, for assembly, in order to mount the pivot member 2 to the frame 10, the sliding plate 24 is first inserted into the limiting slot 125 of the frame 10, and the mounting block 22 of the pivot member 2 is aligned with the pivot hole 124. Thereafter, the mounting block 22 is pushed so that the mounting block 22 is inserted into the pivot hole 124.

Since the buffer slit 222 is formed between the resilient portions 221 so as to provide a resilient property to the mounting block 22, the resilient portions 221 may be forced to move toward one another when the mounting block 22 is inserted into the pivot hole 124. In addition, since the pivot hole 124 is tapered, the enlarged portion 223 of the mounting block 22 may be smoothly inserted into the pivot hole 124.

Continued pushing of the mounting block 22 causes the enlarged portion 223 to extend out of the pivot hole 124. At this time, the resilient portions 221 move away from one another to their original positions by virtue of the restoring force thereof and are retained on the outer section 12 of the frame 10, thereby preventing the pivot member 2 from being released from the frame 10.

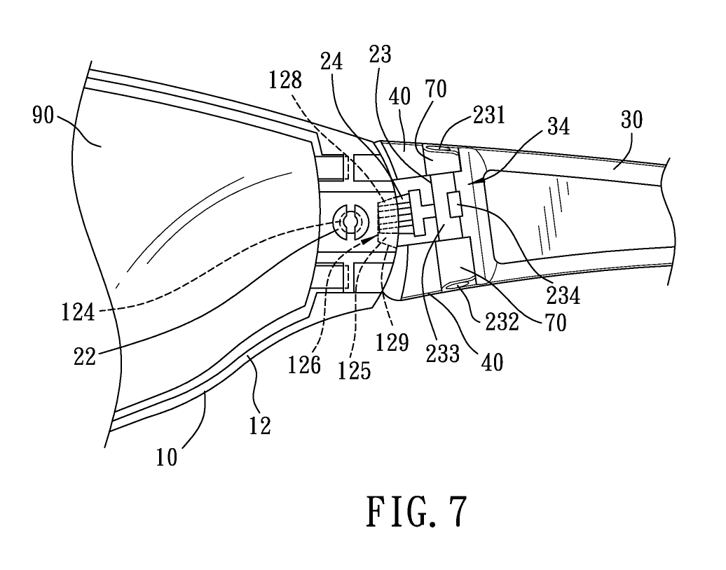

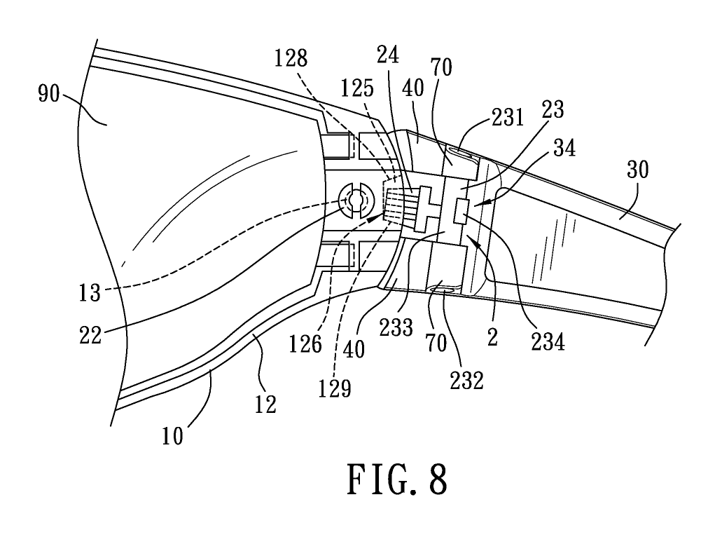

Referring to FIGS. 3, 7, and 8, since the mounting block 22 is cylindrical in shape, it is rotatable in the pivot hole 124 so that the pivot base wall 21 may be pivoted about the mounting block 22. In addition, since the sliding plate 24 is inserted into the limiting slot 125 and is movable within the limiting slot 125, the pivot member 2 is pivotal about the pivot hole 124 relative to the frame 10 between an upper position and a lower position. In the upper position, as illustrated in FIG. 7, the sliding plate 24 abuts against the top face 128 of the slot wall surface 126. On the other hand, in the lower position, as illustrated in FIG. 8, the sliding plate 24 abuts against the bottom face 129 of the slot wall surface 126. Since the top face 128 and the bottom face 129 are sloped faces, they may abut compliantly against the sliding plate 24.

Referring to FIGS. 3, 5 and 6, when the temple unit 3 is to be mounted on the frame 10, the pivot rod 23 is first placed in the positioning recess 34 to align the mouth portion 81 of the upper hook member 70 with the upper portion 231 of the pivot rod 23 and to align the mouth portion 81 of the lower hook member 70 with the lower portion 232 of the pivot rod 23. The temple body 30 is then pulled to cause the pivot rod 23 to snap into the hook members 70 through the mouth portions 81. Since the hook members 70 and the pivot rod 23 are circular in cross section, the temple unit 3 can be pivoted about the pivot rod 23 relative to the frame 10 between an unfolded position and a laterally extended, folded position. At this time, the pivot base wall 21 is received in the temple recess 50, and the outer peripheral edge of the outer section 12 of the frame 10 is located in the end notch 43 of the temple unit 3. Therefore, the temple unit 3 and the frame 10 are engaged movably with one another by virtue of the end notch 43 and the frame recessed portion 123.

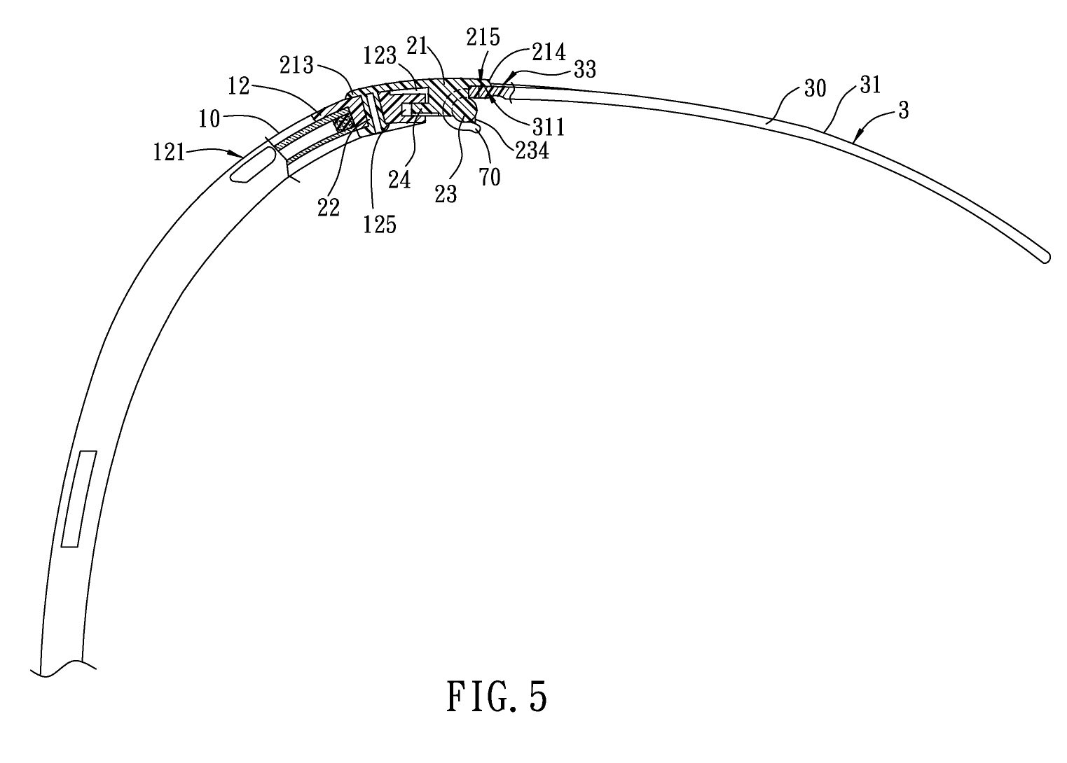

In the unfolded position as shown in FIG. 5, the temple unit 3 extends in a generally front-to-rear direction and may be supported on a wearer's ears (not shown). The rear end 214 of the inner wall surface 212 is overlapped with the temple body 30 so as to abut against the temple body 30. The abutting section 215 of the pivot base wall 21 abuts against the abutting section 311 of the outer face 31 of the temple body 30. At this time, the rear end 214 of the pivot base wall 21 is received in the temple outer groove 33 of the temple body 30. Therefore, in the unfolded position, the temple unit 3 may be fully stretched and the temple outer face 31 of the temple body 30 may be flush with the frame front face 121 of the frame 10.

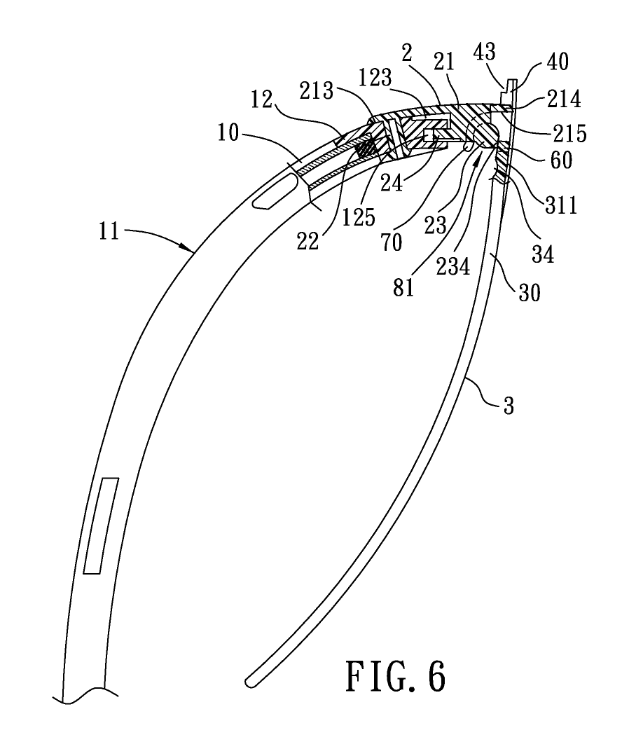

In the folded position as shown in FIG. 6, the temple body 30 is positioned behind the lens unit 1. At this time, the projection 60 abuts against the protrusion 234, and the rear end 214 is not overlapped with the temple body 30.

When the wearer wants to detach the temple unit 3, the temple unit 3 is moved to the folded position and a force is exerted on the temple unit 3 to slide the pivot rod 23 out of the mouth portion 81, thereby separating the temple unit 3 from the pivot member 2. At this time, the wearer may attach another type of temple unit 3 to the pivot member 2. Since the temple unit 3 maybe directly attached to the pivot member 2 in a snap-in manner to assemble with the lens unit 1, the eyeglasses assembly of the present preferred embodiment has an improved convenience for attaching and detaching the temple unit 3.

Referring to FIGS. 3, 7 and 8, since the temple unit 3 is retained on the pivot member 2, and the pivot member 2 is pivotal between the upper position and the lower position. The temple unit 3 is not only pivotal between the unfolded position and the folded position, but also movable upward and downward together with the pivot member 2. Because the frame recessed portion 123 extends curvedly adjacent the edge of the outer section 12 to engage the end notch 43 of each of the temple units 3, the pivot end portions 40 are extended into the frame recessed portion 123 and are permitted to pivot upward and downward together with the pivot member 2. Accordingly, different sloped angles may be provided for the wearers to obtain enhanced comfortability of wearing.

On the other hand, referring to FIGS. 3, 5 and 6, when the temple unit 3 is moved from the unfolded position to the folded position, the projection 60 abuts against the protrusion 234 as the folded position is reached so that the temple unit 3 can not move further toward the lens unit 1. Therefore, the temple unit 3 will not impact or contact the lenses 90, thereby avoiding damages caused to the lenses 90. When the temple unit 3 is moved to the unfolded position, the temple body 30 of the temple unit 3 contacts against the abutting section 215 of the pivot member 2 so that the temple unit 3 is prevented from moving outward further. The temple unit 3 is thus held in position. In addition, the sliding plate 24 is movable upward and downward within the limiting slot 125, which limits the range of movements of the sliding plate 24. Because the range of horizontal movements of the temple unit 3 is limited by the projection 60, the protrusion 234 and the abutting section 215, and because the upward and downward inclining angles of the temple unit 3 are limited by the limiting slot 125, the wearer is permitted to manipulate the eyeglasses assembly accurately.

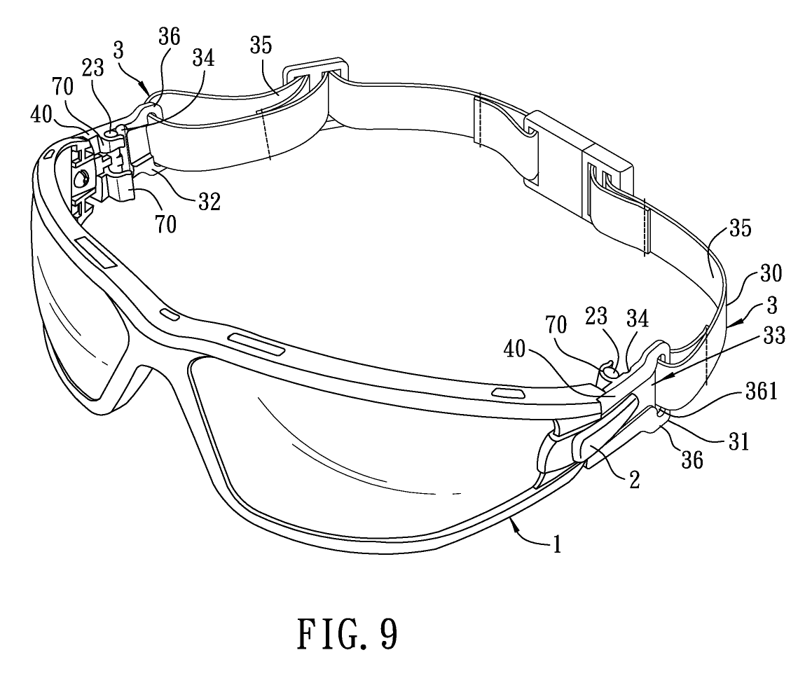

Referring to FIG. 9, a second preferred embodiment of eyeglasses assembly of the present invention, which is generally similar to the first preferred embodiment in structure, comprises a lens unit 1, a pair of pivot members 2 disposed on two sides of the lens unit 1, and a pair temple units 3 disposed on two sides of the lens units 1. The hook members 70 of the temple units 3 are connected respectively to the pivot end portions 40, and the pivot rods 23 of the pivot members 2 are used to assemble the lens unit 1 with the temple units 3.

In this embodiment, the temple body 30 of each of the temple units 3 has a body portion 35, an end portion 36 formed on a front end of the body portion 35, a temple outer face 31 that faces outwardly, a temple inner face 32 opposite to the temple outer face 31, a temple outer groove 33 formed in the temple outer face 31, and a positioning recess 34 that is formed in the temple inner face 32 and that extends in a top-bottom direction. The temple outer face 31 and the temple inner face 32 are formed on the end portion 36. The end portion 36 has a strap hole 361 formed therethrough. In this embodiment, the body portion 35 is an elastic band that has two ends looped and caused to extend through the strap hole 361. In addition, the pivot end portions 40 are formed on a front end of the end portion 36. In this way, the second preferred embodiment provides another type of the temple unit 3 that can also be replaced conveniently.

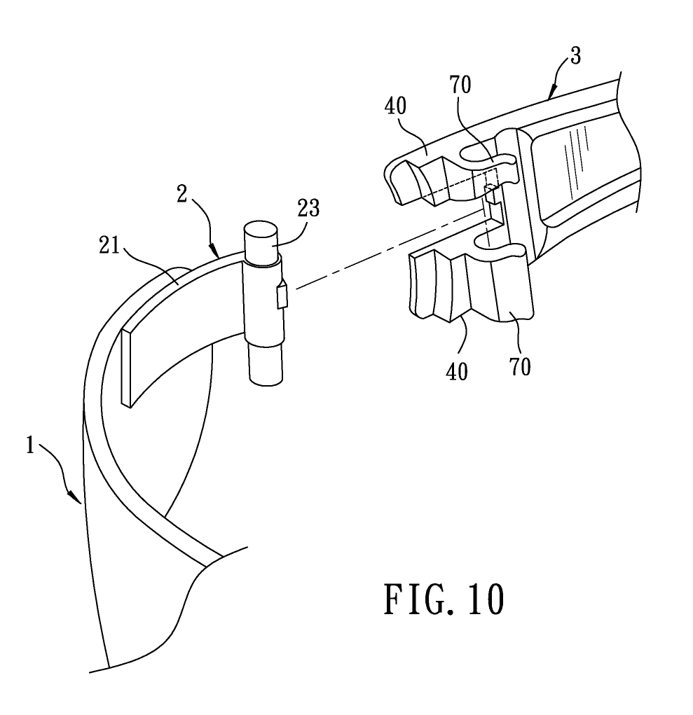

Referring to FIG. 10, a third preferred embodiment of the eyeglasses assembly of the present invention, which is generally similar to the first preferred embodiment in function and structure, comprises a lens unit 1, a pair of pivot members 2 disposed on two sides of the lens unit 1, and a pair temple units 3 disposed on two sides of the lens units 1. The hook members 70 of the temple units 3 are connected respectively to the pivot end portions 40, and the pivot rods 23 of the pivot members 2 are used to assemble the lens unit 1 with the temple unit 3.

The third preferred embodiment differs from the first preferred embodiment in that the pivot members 2 are fixed directly to the opposite sides of the lens unit 1. Specifically, the pivot base wall 21 of each of the pivot members 2 is integrally formed as one piece with the lens unit 1. Although the connection means of the pivot member 2 and the lens unit 1 is altered, the temple unit 3 can still be assembled and disassembled conveniently.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An eyeglasses assembly comprising:
a lens unit;
a pair of pivot units disposed respectively on two sides of said lens unit, and each of said pivot member including a pivot rod; and
a pair of temple units that are engaged respectively to said pivot rods of said pivot units, each of said temple units including a temple body, and two hook members that are spaced apart from one another in a top-bottom direction in proximity to an end of said temple body, said hook members of each of said temple units being engaged detachably to a respective one of said pivot rods to assemble said temple body to said lens unit and to enable said temple body to pivot relative to the lens unit between a folded position and an unfolded position.

2. The eyeglasses assembly as claimed in claim 1, wherein said lens unit has a pair of frames oriented in a left-right direction, and two lenses mounted respectively in said frames, each of said frames having an inner section that is proximate to the other one of said frames, and an outer section that is distal from the other one of said frames, said pivot members being mounted respectively on said outer sections of said frames, said pivot rod of each of said pivot members extending in a top-bottom direction and having an upper portion that is proximate to an upper end thereof and a lower portion that is proximate to a lower end thereof, said upper portion being engaged by an upper one of said hook members, said lower portion of said pivot rod being engaged by a lower one of said hook members.

3. The eyeglasses assembly as claimed in claim 2, wherein said pivot rod of each of said pivot members further has an intermediate portion that interconnects said upper portion and said lower portion, and a protrusion that projects from said intermediate portion, each of said temple units further including a projection that protrudes from an end of said temple body between said hook members, said projection of said pivot rod abutting against said protrusion of said temple body when the respective one of said temple units is in said folded position.

4. The eyeglasses assembly as claimed in claim 3, wherein said temple body of each of said temple units has a temple outer face that faces outwardly and a temple inner face opposite to said temple outer face, said temple outer face having an abutting section adjacent to a front end of said temple body, each of said pivot members further including a pivot base wall that projects from said outer section of a respective one of said frames, said pivot base wall having an outer wall surface that faces outwardly, an inner wall surface that faces toward the respective one of said frames, a rear end that extends laterally from said outer section of the respective one of said frames, and a front end opposite to said rear end, said inner wall surface of said pivot base wall having an abutting section that is adjacent to said rear end of said pivot base wall, said abutting section of said pivot base wall abutting against said abutting section of said temple outer face when said temple body is in said unfolded position, said intermediate portion of said pivot rod being connected to said inner wall surface of said pivot base wall in proximity to said rear end of said pivot base wall.

5. The eyeglasses assembly as claimed in claim 4, wherein said outer section of each of said frames has a pivot hole, each of said pivot members further including a mounting block that projects from said pivot base wall and that is inserted rotatably in said pivot hole, said pivot base wall being pivotal upward and downward in unison with said mounting block.

6. The eyeglasses assembly as claimed in claim 5, wherein each of said pivot members further includes a sliding plate that is spaced apart from said pivot base wall, and is disposed between said pivot rod and said mounting block, said outer section of each of said frames further having a limiting slot into which said sliding plate is inserted slidably to limit a range of upward and downward pivoting movements of said pivot base wall.

7. The eyeglasses assembly as claimed in claim 6, wherein said mounting block of each of said pivot members has a pair of spaced apart resilient portions that project from the inner wall surface of said pivot base wall, and a buffer slit that is formed between said resilient portions, each of said resilient portions having an enlarged portion that projects transversely from a free end thereof, said enlarged portion being insertable through said pivot hole to abut against said outer section of the respective one of said frames.

8. The eyeglasses assembly as claimed in claim 7, wherein said temple body of each of said temple units has a temple outer groove that is formed in said temple outer face thereof and that extends along an length direction thereof, said abutting section of said temple outer face of said temple body being formed in said temple outer groove, said rear end of said pivot base wall being positioned in said temple outer groove of said temple body when the respective one of said temple units is in said unfolded position so that said temple outer face is substantially flush with the respective one of said frames.

9. The eyeglasses assembly as claimed in claim 7, wherein each of said temple units further includes two spaced-part pivot end portions that are connected to a front end of said temple body, each of said pivot end portions having a pivot outer face that faces outwardly, a pivot inner face opposite to said pivot outer face, and an end notch that is indented from said pivot inner face at an end thereof, said hook members of each of said temple units being disposed on said pivot inner face of each of said temple units, said outer section of each of said frames further having a frame front face that is adjacent to a front side thereof, a frame rear face opposite to said frame front face, and a frame recessed portion that extends along an outer peripheral edge of said frame front face and that is indented from said frame front face, said pivot end portions having ends movably extending into said frame recessed portion, an outer side of said outer section of each of said frames extending into said end notch of said pivot end portions of the respective one of said temple units.

10. The eyeglasses assembly as claimed in claim 7, wherein said temple body of each of said temple units further has a positioning recess that extends in a top-bottom direction and that is formed in said temple inner face of said temple body, said positioning recess being located on an end of said temple inner face and being proximate to said hook members.

11. The eyeglasses assembly as claimed in claim 1, wherein said pivot members are formed as one piece with said lens unit.
